(19) United States
(12) Patent Application Publication
(10) Pub. No.: US 2025/0069431 A1
(43) Pub. Date: Feb. 27, 2025

(54) ELECTRONIC DEVICE, METHOD, AND NON-TRANSITORY COMPUTER-READABLE MEDIUM FOR VERIFYING IDENTITY DOCUMENTS

(71) Applicant: AuthMe Co., Ltd., Taipei (TW)

(72) Inventors: CHI-KUANG LEE, Taipei (TW); YOU-SHENG SHIU, Hsinchu (TW); SIN-YI CHENG, Hsinchu (TW)

(21) Appl. No.: 18/814,819

(22) Filed: Aug. 26, 2024

Related U.S. Application Data
(60) Provisional application No. 63/534,646, filed on Aug. 25, 2023.

(51) Int. Cl. G06V 30/42; G06V 30/41

(52) U.S. Cl. CPC G06V 30/42; G06V 30/41

(57) ABSTRACT

The present disclosure provides a method for verifying an identity document. The method includes: obtaining a first image; detecting whether the identity document is presented in the first image; determining whether a type of the identity document belongs to a predetermined type after detecting that the identity document presents in the first image; obtaining a second image of the identity document after determining that the type of the identity document belongs to the predetermined type, wherein the identity document in the second image presents an anti-counterfeiting pattern thereon; determining whether the anti-counterfeiting pattern presented in the second image matches a predetermined anti-counterfeiting pattern; and determining that the identity document is a legitimate identification document after determining that the anti-counterfeiting pattern matches the predetermined anti-counterfeiting pattern. The present disclosure also provides an electronic device for verifying an identity document.

### CROSS-REFERENCE TO RELATED APPLICATION(S)

The present disclosure claims the benefit of and priority to U.S. Provisional Patent Application Ser. No. 63/534,646, filed on Aug. 25, 2023, entitled “DIGITAL IDENTITY MANAGEMENT_SECUREID FOR PERSONAL VERIFICATION AND INTEGRATION,” the content of which is hereby incorporated herein fully by reference into the present disclosure for all purposes.

### FIELD

The present disclosure relates to a device and a method for verifying an identity document, and particularly to a device and method for diversely verifying an identity document.

### BACKGROUND

With the development of technology and the rapid drive for digital transformation, counterfeiting techniques and fraud techniques have continuously evolved, increasing the risk of illegal activities. In such a situation, the need to prevent various potential threats, particularly the need for conducting identity verification through digital means, becomes more urgent to ensure security among all parties. However, the level of identity verification required varies across different application scenarios. Therefore, the present disclosure introduces a method for dynamically verifying an identity, and with flexible architectures, different methods for verifying identities can be flexibly selected according to requirements to meet different strengths of needs for verifying identities.

### SUMMARY

The method provided by the present disclosure for verifying an identity document includes: obtaining a first image; detecting whether the identity document is presented in the first image; determining whether a type of the identity document belongs to a predetermined type after detecting that the identity document presents in the first image; obtaining a second image of the identity document after determining that the type of the identity document belongs to the predetermined type, wherein the identity document in the second image presents an anti-counterfeiting pattern thereon; determining whether the anti-counterfeiting pattern presented in the second image matches a predetermined anti-counterfeiting pattern; and determining that the identity document is an authentic identification document after determining that the anti-counterfeiting pattern matches the predetermined anti-counterfeiting pattern.

In an embodiment of the present disclosure, the first image has a first area where the identity document is presented, and the method further includes: determining whether at least one image quality parameter corresponding to the first area meets a predetermined standard; and determining whether the anti-counterfeiting pattern presented in the second image matches the predetermined anti-counterfeiting pattern after determining that the at least one image quality parameter meets the predetermined standard.

In an embodiment of the present disclosure, the method further includes: determining whether a color of the identity document presented in the first image matches a predetermined color after determining that the type of the identity document belongs to the predetermined type; and obtaining the second image of the identity document after determining that the color matches the predetermined color and determining that the type of the identity document belongs to the predetermined type.

In an embodiment of the present disclosure, the method further includes: performing an optical character recognition on the identity document presented in the first image to obtain at least one piece of identity information; determining whether the at least one piece of identity information is the same as a predetermined piece of identity information; and determining that the identity document is an authentic identity document after determining that the at least one piece of identity information is the same as the predetermined piece of identity information and determining that the anti-counterfeiting pattern matches the predetermined anti-counterfeiting pattern.

In an embodiment of the present disclosure, the identity document has a portrait, and the method further includes: extracting the portrait from the first image; obtaining a third image of an owner of the identity document; performing a facial comparison between the portrait and the third image to obtain a similarity parameter; determine whether the similarity parameter is higher than a threshold value; and determining that the owner is an authentic owner after determining that the similarity parameter is higher than the threshold value.

In an embodiment of the present disclosure, the method further includes: displaying an image capturing window; obtaining a fourth image within the image capturing window; determining whether a first facial image is presented in the fourth image; providing an action indication after determining that the first facial image is presented in the fourth image; obtaining a fifth image within the image capturing window, wherein a second facial image is presented in the fifth image; determining whether the second facial image meets an expression standard based on the action indication; performing a facial comparison between the first facial image and the second facial image to obtain a similarity parameter after determining that the second facial image meets the expression standard; determining whether the similarity parameter is higher than a threshold value; and determining that an owner of the identity document is a live owner after determining that the similarity parameter is higher than the threshold value.

Another embodiment of the present disclosure further provides an electronic device for verifying an identity document, and the electronic device includes: a processor, a display, and a storage. The display is electrically coupled to the processor. The storage is electrically coupled to the processor and configured to store a plurality of computer-executable instructions. The plurality of computer-executable instructions, when executed by the processor, cause the electronic device to perform the method of the present disclosure.

Another embodiment of the present disclosure further provides a non-transitory computer-readable medium that stores a plurality of computer-executable instructions. The plurality of computer-executable instructions, when executed by one or more processors, cause an electronic device to perform the method of the present disclosure.

### BRIEF DESCRIPTION OF THE DRAWINGS

Aspects of the present disclosure are best understood from the following detailed disclosure when read with the accompanying drawings.

FIG. 1 is a schematic architectural diagram of a system for verifying an identity document according to an embodiment of the present disclosure.

FIG. 2A and FIG. 2B are schematic diagrams of an operation interface of an application program according to an embodiment of the present disclosure.

FIG. 3A and FIG. 3B are schematic diagrams of an operation interface of an application program according to another embodiment of the present disclosure.

FIG. 4 is a schematic diagram of signaling and channels among various devices in a system for verifying an identity document according to an embodiment of the present disclosure.

FIG. 5 is a flow chart of a method for verifying an identity document according to a first embodiment of the present disclosure.

FIG. 6 is a flow chart of a method for verifying an identity document according to a second embodiment of the present disclosure.

### DETAILED DESCRIPTION

In the present disclosure, unless the article is specifically limited in the context, “a” and “the” can generally refer to one or more.

In addition, the terms “include,” “comprise,” “have” and the like used in the present disclosure are open-ended terms that imply the inclusion of the disclosed features, elements and/or components described therein, but do not preclude the presence or addition of one or more additional features, elements, components, and/or their groups described thereof.

Furthermore, the ordinal terms (such as “first,” “second,” “third,” and the like) used in the present disclosure and claims are used to modify an element itself and do not imply any priority or any order of one element over another element, or do not imply a chronological order of steps of a method performed, but are used only as symbols to distinguish a claimed element having a particular name from another element having the same name.

The spirit of the present disclosure will be clearly illustrated with drawings and detailed descriptions below. After understanding the embodiments of the present disclosure, those skilled in the art with ordinary knowledge can make modifications and variations based on the technologies taught in the present disclosure without departing from the spirit and scope of the present disclosure.

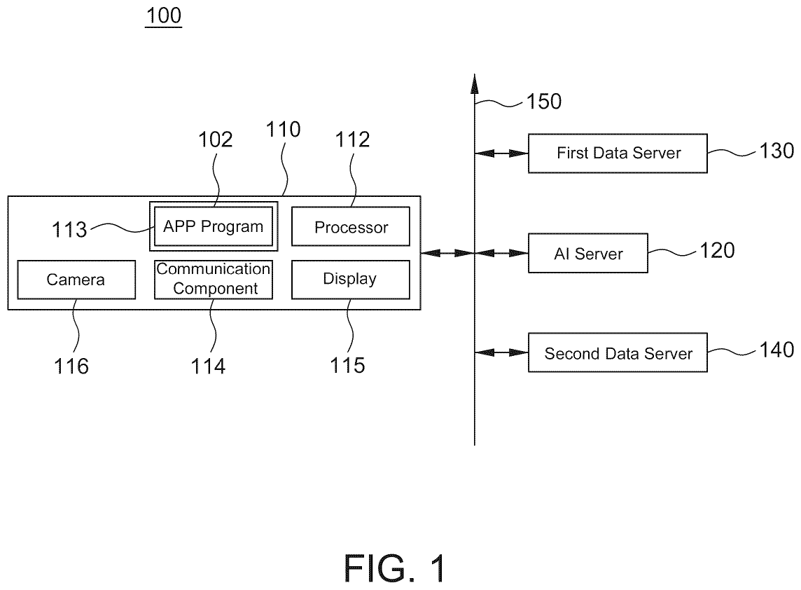

FIG. 1 is a schematic architectural diagram of a system 100 for verifying an identity document according to an embodiment of the present disclosure. Referring to FIG. 1, the system 100 includes an electronic device 110, an artificial intelligence (AI) server 120, a first data server 130 and a second data server 140. The AI server 120, the first data server 130 and the second data server 140 are electronic devices with computing capabilities and networking functions and provide services externally through a network 150. The AI server 120 is configured to provide image or video comparison services, image or video analysis services, optical character recognition, and other services. The first data server 130 is configured to store the portraits of user's identification (ID) documents and provide access services for the portraits. The second data server 140 is configured to store the facial images of the owners of the user's ID documents and provide access services for the facial images.

In the present embodiment, the system 100 provides an application (APP) program 102 for the user to use the services provided by the system 100. In the present embodiment, the services provided by the system 100 include verifying an identity document, verifying whether the owner of the identity document is an authentic owner, and verifying whether the owner of the identity document is a live owner. The first electronic device 110 may be a device used by the owner of the identity document and has the APP program 102 installed thereon.

The electronic device 110 includes a processor 112, a storage 113, a communication component 114, a display 115 and a camera 116. The processor 112 is electrically coupled to the storage 113, the communication component 114, the display 115 and the camera 116. The APP program 102 is stored in the storage 113.

The processor 112 may be, for example, a central processing unit (CPU), a programmable microprocessor, an embedded control chip, a digital signal processor (DSP), or an application specific integrated circuit (ASIC) or the like.

The storage 113 may be, for example, a random access memory (RAM), a read-only memory (ROM), a flash memory, a hard disk, other similar device, or a combination of these devices.

The communication component 114 may be a chip or circuit that employs a wireless local area network (WLAN) technology, a local area network (LAN) technology or a mobile communication technology. The local area network may be, for example, Ethernet. The wireless local area network may be, for example, Wi-Fi. The mobile communication technology may include, for example, Global System for Mobile Communications (GSM), Third Generation (3G), Fourth Generation, Fifth Generation (5G) mobile communication technologies, etc.

The display 115 may be, for example, a liquid crystal display (LCD), an organic light-emitting diode (OLED) display, etc.

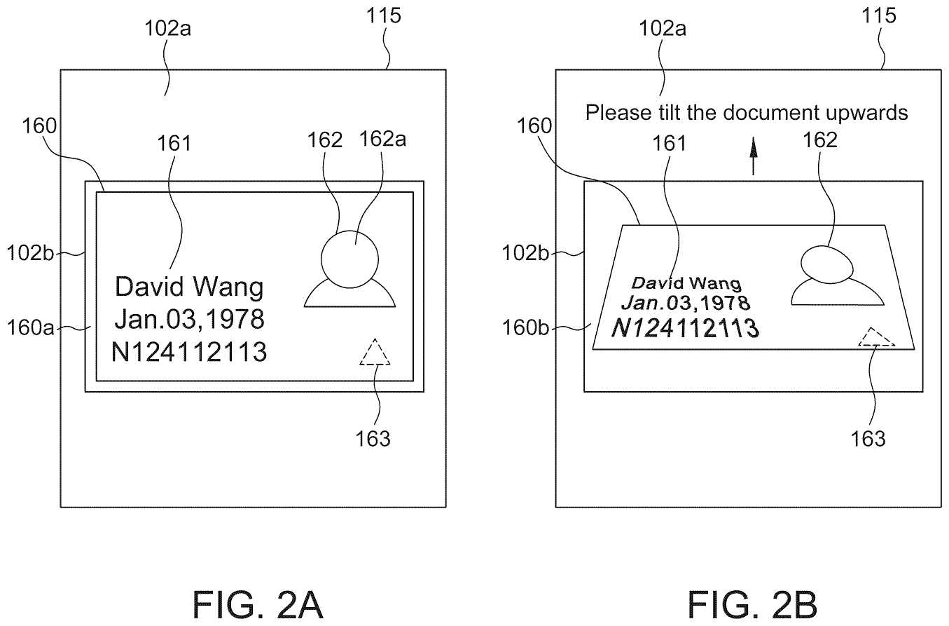

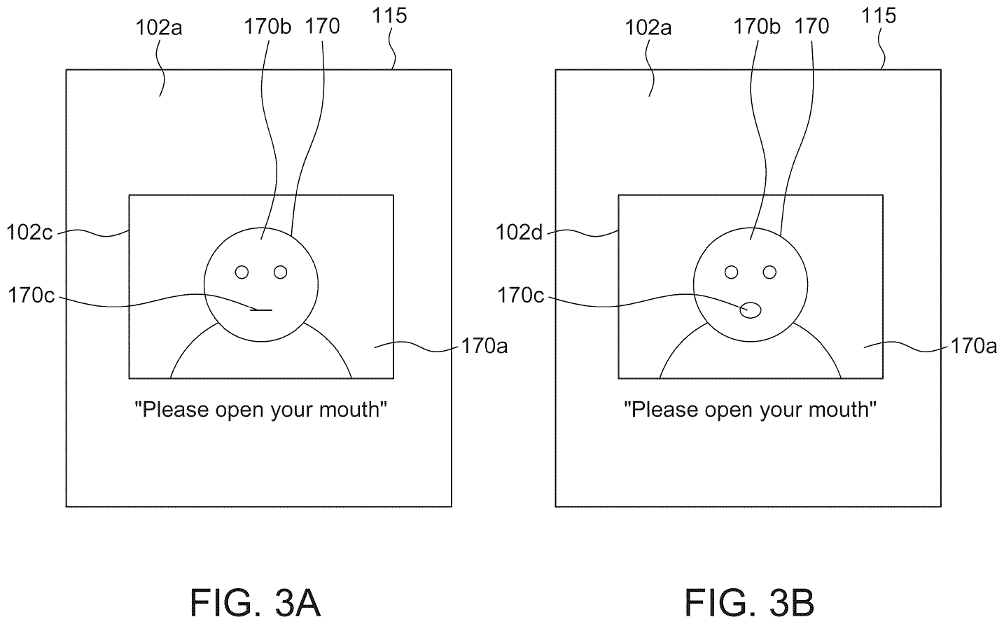

The APP program 102 is installed and stored in the storage 113 of the electronic device 110 and may be executed by the processor 112. When the APP program 102 is executed by the processor 112, an operation interface 102a of the APP program 102 is displayed on the display 115, as shown in FIG. 2A, FIG. 2B and FIG. 3A. Now referring to FIG. 2A, FIG. 2B and FIG. 3A, in one embodiment of the present disclosure, the operation interface 102a of the APP program 102 may provide a first image capturing window 102b configured to obtain an image 160a of an identity document 160 and provide a second image capturing window 170a configured to obtain an image 102c of the owner 170 of the identity document 160. In the present embodiment, the identity document 160 may include at least personal information 161, a portrait 162 and an anti-counterfeiting pattern 163, but is not limited thereto. In the present embodiment, the personal information 161 may include information such as name (e.g., David Wang), birthday (e.g., Jan. 3, 1978), and ID number (e.g., N124112113), but is not limited thereto. In another embodiment, the identity document 160 may be a citizen identity card, a health insurance card, a passport, a natural person certificate, etc., but is not limited thereto.

In addition, the AI server 120, the first data server 130 and the second data server 140 all have components such as a processors, storages and communication components (similar to the above-mentioned processor 112, the storage 113 and the communication component 114).

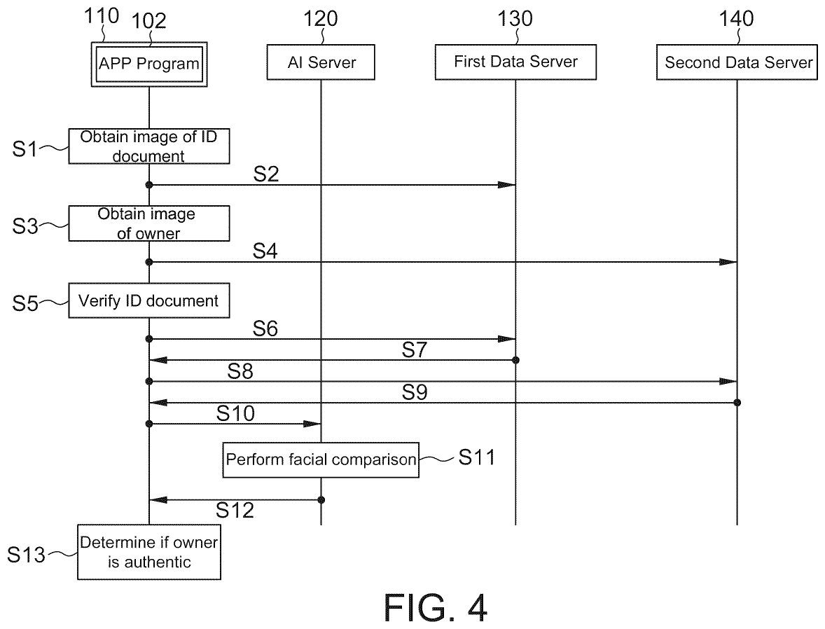

FIG. 4 is a schematic diagram of signaling and channels among various devices in a system for verifying an identity document according to an embodiment of the present disclosure. Referring to FIG. 2A, FIG. 2B, FIG. 3 and FIG. 4, the electronic device 110 uses the services provided by the system 100 through the APP program 102 and performs, through the APP program 102, the method for verifying an identity (ID) document according to the present disclosure. In step S1, the electronic device 110 may obtain the image 160a of the identity document 160. In step S2, the electronic device 110 may upload the obtained image 160a to the first data server 130 to store the image 160a in the first data server 130. In step S3, the electronic device 110 may obtain the image 102c of the owner 170 of the identity document 160. In step S4, the electronic device 110 may upload the obtained image 102c to the second data server 140 to store the image 102c in the second data server 140. In step S5, the electronic device 110 may perform an identity verification process for verifying whether the identity document 160 is a legitimate or authentic identity document. In another embodiment of the present disclosure, the electronic device 110 may further perform a comparison process containing steps S6, S7, S8, S9, S10 and S11 for the owner 170 and the identity document 160 to verify whether the owner 170 of the identity document 160 is an authentic owner after verifying that the identity document 160 is a legitimate or authentic identity document through the identity verification process. In step S6, the electronic device 110 transmits a first downloading request to the first data server 130 to request downloading the image 160a of the identity document 160 stored in the first data server 130. In step S7, the first data server 130 transmits the image 160a of the identity document 160 to the electronic device 110 in response to the first downloading request. In step S8, the electronic device 110 transmits a second downloading request to the second data server 140 to request downloading the image 102c of the owner 170 stored in the second data server 140. In step S9, the second data server 140 transmits the image 102c of the owner 170 to the electronic device 110 in response to the second downloading request. In step S10, the electronic device 110 receives the image 160a of the identity document 160 and the image 102c of the owner 170 from the first data server 130 and the second data server 140 respectively and transmits the image 160a and the image 102c to the AI server 120. In step S11, the AI server 120 receives the image 160a and the image 102c and performs a facial comparison between the portrait 162 presented in the image 160a and the portrait of the owner 170 presented in the image 102c to generate a similarity parameter based on a result of the facial comparison. In another embodiment, the electronic device may have an AI model installed thereon to perform the facial comparison. In step S12, the AI server 120 returns the similarity parameter to the electronic device 110. In step S13, the electronic device 110 receives the similarity parameter and determines whether the similarity parameter is higher than a threshold value to determine whether the owner is an authentic owner. For example, the electronic device 110 may determine that the owner is not an authentic owner after determining that the similarity parameter is lower than the threshold value. On the contrary, the electronic device 110 may determine that the owner is an authentic owner after determining that the similarity parameter is higher than the threshold value.

In the present embodiment, the AI server 120 may have a deep neural network model (referred to as the AI model) configured to select a facial area 162a presented by the portrait 162 in the image 160a and a facial area 170b presented by the portrait of the owner 170 in the image 102c and convert the selected area 162a and the selected area 170b into a first vector value (also known as a first facial feature value) in a high-dimensional space and a second vector value (also known as a second facial feature value) in a high-dimensional space, respectively. Next, when performing the facial comparison, the AI server 120 calculates the distance between the first vector value and the second vector value to obtain the similarity parameter between the first facial feature value and the second facial feature value.

In an alternative embodiment, in step S1, the electronic device 110 may first convert, through the AI server 120, the facial area 162a presented by the portrait 162 in the image 160a into a first vector value (also known as a first facial feature value) in a high-dimensional space and upload the first facial feature value to the first data server 130 to store the first vector value in the first data server 130. Next, in step S6, the electronic device 110 transmits the first downloading request to the first data server 130 to request downloading the first vector value stored in the first data server 130. In step S7, the first data server 130 transmits the first vector value to the electronic device 110 in response to the first downloading request. In step S10, the electronic device 110 receives the first vector value and the image 102c of the owner 170 from the first data server 130 and the second data server 140 respectively and transmits the first vector value and the image 102c to the AI server 120. In step S11, the AI server 120 selects the facial area 170b presented by the portrait of the owner 170 in the image 102c and converts the selected area 170b into a second vector value (also known as a second facial feature value) in a high-dimensional space. Next, when performing the facial comparison, the AI server 120 calculates the distance between the first vector value and the second vector value to obtain the similarity parameter between the first facial feature value and the second facial feature value.

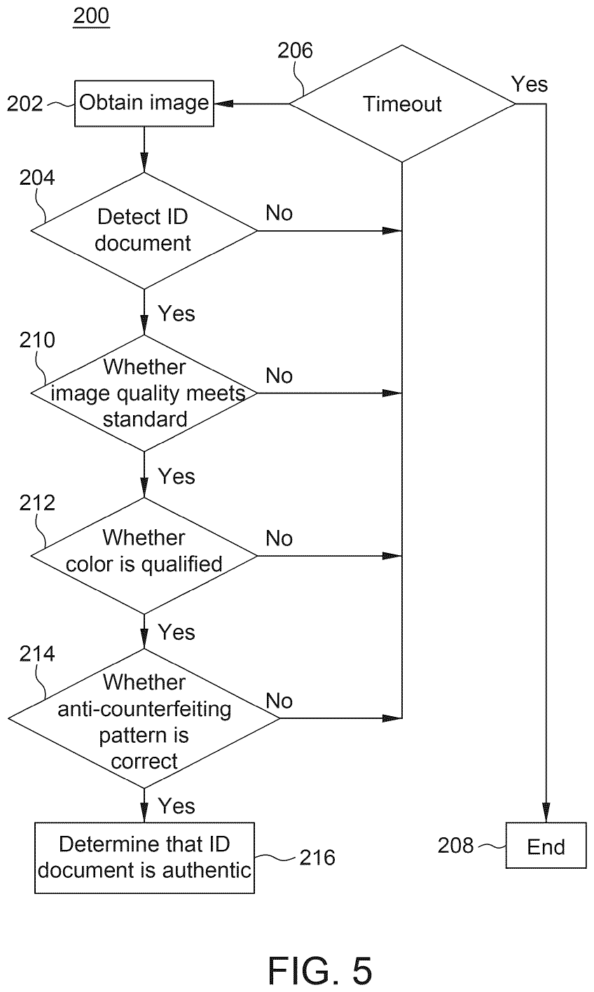

FIG. 5 is a flow chart of a method for verifying an identity document according to a first embodiment of the present disclosure. In the present embodiment, the method for verifying the identity document according to the first embodiment may be performed by the electronic device 110. Referring to FIG. 1 to FIG. 5, in step 202, the electronic device 110 may obtain an image 160a. For example, the electronic device 110 may activate the camera 116 to obtain the image 160a through the first image capturing window 102b provided by the operation interface 102a of the APP program 102.

In step 204, the electronic device 110 detects whether an image of the identity document 160 is presented in the image 160a. When the electronic device 110 detects that the image of the identity document 160 is not presented in the image 160a, the electronic device 110 performs step 206. In addition, after the electronic device 110 detects that the image of the identity document 160 is presented in the image 160a, the electronic device 110 may use a first AI model to determine whether the identity document 160 presented in the image 160a belongs to a predetermined type of identity document (e.g., a citizen ID card). When the electronic device 110 uses the first AI model to determine that the identity document 160 does not belong to the predetermined type, the electronic device 110 may display “Document Error” through the display 115 and perform step 206. When the electronic device 110 uses the first AI model to determine that the identity document 160 belongs to the predetermined type, the electronic device 110 may perform step 210. In the present embodiment, the first AI model is a mathematical and computational model trained and generated by using artificial intelligence (AI) technology (e.g., machine learning or deep learning) to learn from a large amount of image data of identity documents and may be installed on the electronic device 110 or on the AI server 120 to assist in determining whether the identity document 160 presented in the image 160a belongs to the predetermined type of identity document. In one embodiment, the lens of the camera 116 can be aimed at the physical identity document 160, so that the image of the identity document 160 can enter the first image capturing window 102b provided by the operation interface 102a of the APP program 102, and the image 160a containing the image of the identity document 160 can be obtained as shown in FIG. 2A.

In step 206, the electronic device 110 determines whether a predetermined timeout has occurred. When the electronic device 110 determines that the predetermined timeout has occurred, the electronic device 110 performs step 208 to end the operation of verifying the identity document 160. When the electronic device 110 determines that the predetermined time has not occurred, the electronic device 110 performs step 202 again.

In step 210, after the electronic device 110 determines that the identity document 160 belongs to the predetermined type of identity document, the electronic device 110 determines whether the image quality of the identity document 160 presented in the image 160a meets a predetermined standard. When the electronic device 110 determines that the image quality of the identity document 160 does not meet the predetermined standard, the electronic device 110 performs step 206. In addition, when the electronic device 110 determines that the image quality of the identity document 160 meets the predetermined standard, the electronic device 110 performs step 212. In one embodiment, the image 160a has a first area in which the identity document 160 is presented (e.g., an area in which the image of the identity document 160 is presented), and the electronic device 110 may use a second AI model to determine whether an image quality parameter corresponding to the first area meet a predetermined standard. The image quality parameter may include at least one of various image quality parameters used to represent the degree of reflectiveness, occlusion, darkness, and/or alignment of the image of the identity document 160 within the first image capturing window 102b, but is not limited thereto. After the electronic device 110 uses the second AI model to determine that the at least one image quality parameter meets the predetermined standard, the electronic device 110 performs step 212. In addition, after the electronic device 110 uses the second AI model to determine that the at least one parameter does not meet the predetermined standard, the electronic device 110 performs step 206. In the present embodiment, the second AI model is a mathematical and computational model trained and generated by using artificial intelligence (AI) technology (e.g., machine learning or deep learning) to learn from a large amount of image data of identity documents and may be installed on the electronic device 110 or on the AI server 120 to assist in determining whether the image quality parameter corresponding to the first area meets the predetermined standard.

In step 212, after the electronic device 110 determines that the at least one image quality parameter meets the predetermined standard, the electronic device 110 determines whether the image color of the identity document 160 presented in the image 160a is qualified. When the electronic device 110 determines that the image color of the identity document 160 presented in the image 160a is unqualified, the electronic device 110 performs step 206. In addition, when the electronic device 110 determines that the image color of the identity document 160 presented in the image 160a is qualified, the electronic device 110 performs step 214. In one embodiment, the electronic device 110 may use a third AI model to determine whether the image color of the identity document 160 presented in the image 160a matches a predetermined color, thereby determining whether the image color of the identity document 160 is qualified. The image color may be colorful, black, white or grayscale, but is not limited thereto. When the electronic device 110 uses the third AI model to determine that the image color of the identity document 160 presented in the image 160a does not match the predetermined color (that is, the image color of the identity document 160 is unqualified), the electronic device 110 performs step 206. When the electronic device 110 uses the third AI model to determine that the image color of the identity document 160 presented in the image 160a matches the predetermined color (that is, the image color of the identity document 160 is qualified), the electronic device 110 performs step 214. In the present embodiment, the third AI model is a mathematical and computational model trained and generated by using artificial intelligence (AI) technology (e.g., machine learning or deep learning) to learn from a large amount of image data of identity documents and may be installed on the electronic device 110 or on the AI server 120 to assist in determining whether the image color of the identity document 160 presented in the image 160a matches the predetermined color, thereby determining whether the image color of the identity document 160 is qualified.

In step 214, after the electronic device 110 determines that the image color of the identity document 160 presented in the image 160a matches the predetermined color, the electronic device 110 determines whether an anti-counterfeiting pattern 163 on the identity document 160 is correct. When the electronic device 110 determines that the anti-counterfeiting pattern 163 on the identity document 160 is incorrect, the electronic device 110 performs step 206. In addition, when the electronic device 110 determines that the anti-counterfeiting pattern 163 on the identity document 160 is correct, the electronic device 110 performs step 216. In one embodiment, after the electronic device 110 determines that the image color of the identity document 160 presented in the image 160a matches the predetermined color, the electronic device 110 may provide an action indication (e.g., “Please tilt the document upwards”) through the operation interface 102a of the APP program 102 to make the anti-counterfeiting pattern 163 on the identity document 160 reflect light or change color in the first image capturing window 102b as shown in FIG. 2B. When the anti-counterfeiting pattern 163 on the identity document 160 reflects light or changes color in the first image capturing window 102b, the electronic device 110 may use the first image capturing window 102b to obtain another image 160b. In the present embodiment, the anti-counterfeiting pattern 163 may be an explicit or implicit anti-counterfeiting pattern such as a laser perforation pattern, an embossed touch pattern or a refractive color-changing ink and may become clearly visible only from a specific viewing angle. For example, when the front side of the identity document 160 faces the electronic device 110, the anti-counterfeiting pattern 163 may not be clearly visible in the first image capturing window 102b as shown in FIG. 2A. When the identity document 160 is tilted to the electronic device 110 at a specific angle, the anti-counterfeiting pattern 163 may be clearly visible in the first image capturing window 102b as shown in FIG. 2B. However, in an alternative embodiment, when the anti-counterfeiting pattern 163 is clearly visible in the first image capturing window 102b shown in FIG. 2A, the image 160a can directly replace the image 160b, that is, there is no need to obtain the image 160b. In one embodiment, the electronic device 110 may use a fourth AI model to determine whether the anti-counterfeiting pattern 163 presented in the image 160b matches a predetermined anti-counterfeiting pattern, thereby determining whether the anti-counterfeiting pattern 163 on the identity document 160 is correct. When the electronic device 110 uses the fourth AI model to determine that the anti-counterfeiting pattern 163 does not match the predetermined anti-counterfeiting pattern (that is, the anti-counterfeiting pattern 163 is incorrect), the electronic device 110 performs step 206. When the electronic device 110 uses the fourth AI model to determine that the anti-counterfeiting pattern 163 matches the predetermined anti-counterfeiting pattern (that is, the anti-counterfeiting pattern 163 is correct), the electronic device 110 performs step 216. In the present embodiment, the fourth AI model is a mathematical and computational model trained and generated by using artificial intelligence (AI) technology (e.g., machine learning or deep learning) to learn from a large amount of image data of identity documents and may be installed on the electronic device 110 or on the AI server 120 to assist in determining whether the anti-counterfeiting pattern 163 presented in the image 160b matches the predetermined anti-counterfeiting pattern, thereby determining whether the anti-counterfeiting pattern 163 on the identity document 160 is correct.

In step 216, after the electronic device 110 determines that the anti-counterfeiting pattern 163 matches the predetermined anti-counterfeiting pattern, the electronic device 110 may determine that the identity document 160 is an authentic identity document.

In the above embodiment, the order of step 210, step 212 and step 214 is not limited thereto and may be performed in other different orders. In addition, step 210 and step 212 may be selectively omitted or not performed based on different application scenarios. For example, in one embodiment, in a case that step 212 is omitted or not performed, after the electronic device 110 determines in step 210 that the at least one image quality parameter meets the predetermined standard, the electronic device 110 may perform step 214 to determine whether the anti-counterfeiting pattern 163 presented in the image 160b matches the predetermined anti-counterfeiting pattern, thereby determining whether the anti-counterfeiting pattern 163 on the identity document 160 is correct.

In other embodiments of the present disclosure, the above-mentioned method for verifying an identity document may further include a step of performing an optical character recognition to enhance the determination that the identity document 160 is an authentic identity document. The step of performing the optical character recognition may be performed by the electronic device 110 before step 214 or may be performed by the electronic device 110 after step 214. In the step of performing the optical character recognition, the electronic device 110 may perform the optical character recognition on the image of the identity document 160 presented in the image 160a or the image 160b to obtain the identity information (e.g., name, birthday and/or ID number) on the identity document 160. After obtaining the identity information on the identity document 160, the electronic device 110 determines whether at least one piece of the identity information (e.g., name, birthday, and ID number) matches predetermined identity information. When the electronic device 110 determines that the at least one piece of the identity information does not match the predetermined identity information, the electronic device 110 performs step 206. After the electronic device 110 determines that the at least one of piece of the identity information matches the predetermined identity information and determines that the anti-counterfeiting pattern 130 matches the predetermined anti-counterfeiting pattern, the electronic device 110 performs step 216 to determine that the identity document 160 is an authentic identity document.

In a second embodiment of the present disclosure, the method illustrated in FIG. 5 may further include step S6 to step S13 as shown in FIG. 4 to further determine whether the owner of the identity document 160 is an authentic owner.

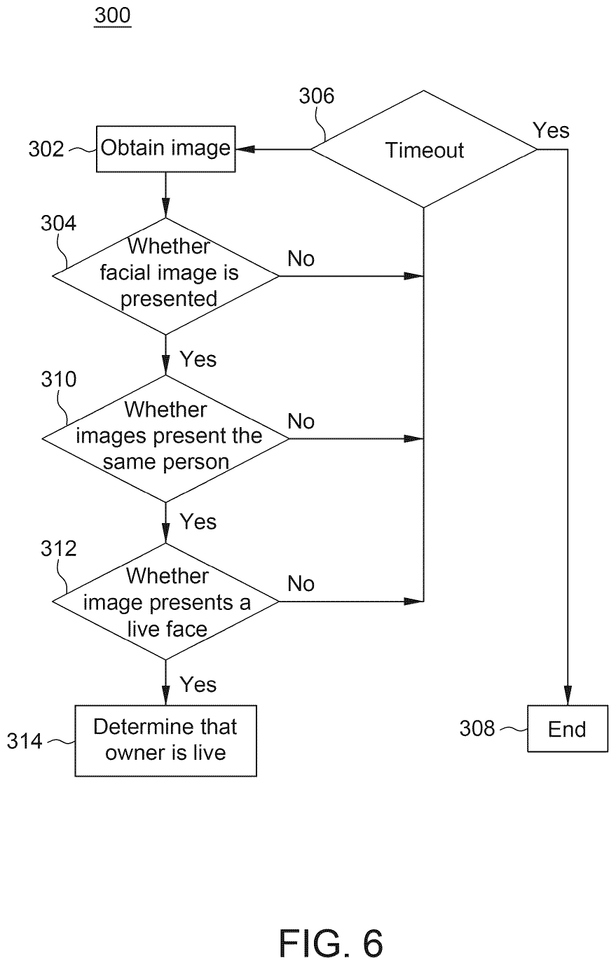

In a third embodiment of the present disclosure, the method illustrated in FIG. 5 may further include step 302 to step 314 (as shown in the flow chart of FIG. 6). The second embodiment of the present disclosure describes that the method for verifying the identity document according to the first embodiment may further determine whether the owner of the identity document 160 is a living owner rather than an illegally disguised owner. Referring to FIG. 1, FIG. 3A, FIG. 3B and FIG. 6, the electronic device 110 may further perform step 302 to step 314 to determine whether the owner 170 of the identity document 160 is a live owner. In step 302, the electronic device 110 may obtain an image 102c as shown in FIG. 3A. For example, the electronic device 110 may activate the camera 116 and use the display 115 to display the second image capturing window 170a to obtain the image 102c presented in the second image capturing window 170a.

In step 304, the electronic device 110 detects whether a facial image is presented in the image 102c. When the electronic device 110 detects that no facial image is presented in the image 102c, the electronic device 110 performs step 306. In addition, when the electronic device 110 detects that a facial image (e.g., facial area 170b) is presented in the image 102c, the electronic device 110 performs step 310. In the present embodiment, the electronic device 110 may detect whether facial features are presented in the facial area 170b, thereby determining whether a facial image is presented in the image 102c. When the electronic device 110 detects that the facial features are presented in the facial area 170b, the electronic device 110 may determine that a facial image is presented in the image 102c.

In step 306, the electronic device 110 determines whether a predetermined timeout has occurred. When the electronic device 110 determines that the predetermined timeout has occurred, the electronic device 110 performs step 308 to end the operation of determining the live owner. When the electronic device 110 determines that the predetermined time has not occurred, the electronic device 110 performs step 302 again.

In step 310, after the electronic device 110 determines that the facial image is presented in the image 102c, the electronic device 110 obtains another image 102d (as shown in FIG. 3B) and performs a comparison between the image 102c and the image 102d to determine whether the facial image presented in the image 102c and the facial image presented in the image 102d present the same person. When the electronic device 110 determines that the facial image presented in the image 102c and the facial image presented in the image 102d do not present the same person, the electronic device 110 performs step 306. In addition, when the electronic device 110 determines that the facial image presented in the image 102c and the facial image presented in the image 102d present the same person, the electronic device 110 performs step 312. In one embodiment, the electronic device 110 displays an action indication (e.g., “Please open your mouth”) through the display 115 and obtains another image 102d through the second image capturing window 170a. Another facial image is presented in the image 102d. Next, the electronic device 110 determines whether the facial image presented in the image 102d meets an expression standard (e.g., a face with an open mouth) based on the action indication (e.g., “Please open your mouth”). In the present embodiment, a mouth image 170c of the facial image in the image 102c presents a closed mouth, and the mouth image 170c of the facial image in the image 102d presents an open mouth. After determining that the facial image presented in the image 102d meets the expression standard, the electronic device 110 performs a facial comparison between the facial image presented in the image 102c and the facial image presented in the image 102d to obtain a similarity parameter. Next, the electronic device 110 may determine whether the similarity parameter is higher than a threshold value. After determining that the similarity parameter is higher than the threshold value, the electronic device 110 may determine that the facial image presented in the image 102c and the facial image presented in the image 102d present the same person, thereby further determining that the owner of the identity document is a live owner.

In step 310, after the electronic device 110 determines that the facial image presented in the image 102c and the facial image presented in the image 102d present the same person, the electronic device 110 may use a fifth AI model to determine whether the facial image presented in the second image capturing window 170a presents a live face. When the electronic device 110 uses the fifth AI model to determine that the facial image presented in the second image capturing window 170a does not present a live face, the electronic device 110 performs step 306. In addition, when the electronic device 110 uses the fifth AI model to determine that the facial image presented in the second image capturing window 170a presents a live face, the electronic device 110 performs step 314. In the present embodiment, the fifth AI model is a mathematical and computational model trained and generated by using artificial intelligence (AI) technology (e.g., machine learning or deep learning) to learn from a large amount of image data of identity documents and may be installed on the electronic device 110 or on the AI server 120 to assist in determining whether the facial image presented in the second image capturing window 170a presents a live face. For example, the fifth AI model may determine whether the facial image presents a live face by determining an expression change or a facial pulse change of the facial image presented in the second image capturing window 170a.

In step 314, after the electronic device 110 uses the fifth AI model to determine that the facial image presented in the second image capturing window 170a presents a live face, the electronic device 110 determines that the owner of the identity document 160 is a live owner.

The disclosure also provides a non-transitory computer-readable medium that stores a plurality of computer-executable instructions. The plurality of computer-executable instructions, when executed by one or more processors, cause an electronic device (e.g., the electronic device 110 shown in FIG. 1) to perform the method for verifying an identity document as described in the above embodiments. In one embodiment of the present disclosure, the non-transitory computer readable medium may be, for example, a hard disk, an optical disc, a universal serial bus (USB) flash drive, a solid-state drive (SSD), etc., but is not limited thereto.

Although the present disclosure has been disclosed by way of above embodiments, the embodiments are not intended to limit the present disclosure, and those skilled in the art will appreciate that changes and modifications may be made therein as long as those changes and modifications do not deviate from the spirit and the scope of the present disclosure. Therefore, the scope of the present disclosure should be construed according to the definitions in the appended claims.

1. A method for verifying an identity document, comprising:
obtaining a first image;
detecting whether the identity document is presented in the first image;
determining whether a type of the identity document belongs to a predetermined type after detecting that the identity document is presented in the first image;
obtaining a second image of the identity document after determining that the type of the identity document belongs to the predetermined type, wherein the identity document in the second image presents an anti-counterfeiting pattern thereon;
determining whether the anti-counterfeiting pattern resented in the second image matches a predetermined anti-counterfeiting pattern; and
determining that the identity document is an authentic identification document after determining that the anti-counterfeiting pattern matches the predetermined anti-counterfeiting pattern.

2. (canceled)

3. The method of claim 1, wherein the first image has a first area where the identity document is presented, and the method further comprises:
determining whether at least one image quality parameter corresponding to the first area meets a predetermined standard; and
determining whether the anti-counterfeiting pattern presented in the second image matches the predetermined anti-counterfeiting pattern after determining that the at least one image quality parameter meets the predetermined standard.

4. The method of claim 1, further comprising:
determining whether a color of the identity document presented in the first image matches a predetermined color after determining that the type of the identity document belongs to the predetermined type; and
obtaining the second image of the identity document after determining that the color matches the predetermined color and determining that the type of the identity document belongs to the predetermined type.

5. The method of claim 1, further comprising:
performing an optical character recognition on the identity document presented in the first image to obtain at least one piece of identity information;
determining whether the at least one piece of identity information is the same as a predetermined piece of identity information; and
determining that the identity document is an authentic identity document after determining that the at least one piece of identity information is the same as the predetermined piece of identity information and determining, that the anti-counterfeiting pattern matches the predetermined anti-counterfeiting pattern.

6. The method of claim 1, wherein the identity document has a portrait, and the method further comprises:
extracting the portrait from the first image;
obtaining a third image of an owner of the identity document;
performing a facial comparison between the portrait and the third image to obtain a similarity parameter;
determine whether the similarity parameter is higher than a threshold value; and
determining that the owner is an authentic owner after determining that the similarity parameter is higher than the threshold value.

7. The method of claim 1, further comprising:
displaying an image capturing window;
obtaining a fourth image within the image capturing window;
determining whether a first facial image is presented in the fourth image;
providing an action indication after determining that the first facial image is presented in the fourth image;
obtaining a fifth image within the image capturing window, wherein a second facial image is presented in the fifth image;
determining whether the second facial image meets an expression standard based on the action indication;
performing a facial comparison between the first facial image and the second facial image to obtain a similarity parameter after determining that the second facial image meets the expression standard;
determine whether the similarity parameter is higher than a threshold value; and
determining that an owner of the identity document is a live owner after determining that the similarity parameter is higher than the threshold value.

8. An electronic device for verifying an identity document, comprising:
a processor;
a display electrically coupled to the processor; and
a storage electrically coupled to the processor and configured to store a plurality of computer-executable instructions, wherein the plurality of computer-executable instructions, when executed by the processor, cause the electronic device to:
obtain a first image;
detect whether the identity document is presented in the first image;
determine whether a type of the identity document belongs to a predetermined type after detecting that the identity document is presented in the first image;
obtain a second image of the identity document after determining that the type of the identity document belongs to the predetermined type, wherein the identity document in the second image presents an anti-counterfeiting pattern thereon;
determine whether the anti-counterfeiting pattern presented in the second image matches a predetermined anti-counterfeiting pattern; and
determine that the identity document is an authentic identification document after determining that the anti-counterfeiting pattern matches the predetermined anti-counterfeiting pattern.

9. The electronic device of claim 7, wherein the first image has a first area where the identity document is presented, and the plurality of computer-executable instructions, when executed by the processor, further cause the electronic device to:
determine whether at least one image quality parameter corresponding to the first area meets a predetermined standard; and
determine whether the anti-counterfeiting pattern presented in the second image matches the predetermined anti-counterfeiting pattern after determining that the at least one image quality parameter meets the predetermined standard.

10. The electronic device of claim 7, wherein the plurality of computer-executable instructions, when executed by the processor, further cause the electronic device to:
determine whether a color of the identity document presented in the first image matches a predetermined color after determining that the type of the identity document belongs to the predetermined type; and
obtain the second image of the identity document after determining that the color matches the predetermined color and determining that the type of the identity document belongs to the predetermined type.

11. The electronic device of claim 7, wherein the plurality of computer-executable instructions, when executed by the processor, further cause the electronic device to:
perform an optical character recognition on the identity document presented in the first image to obtain at least one piece of identity information;
determine whether the at least one piece of identity information is the same as a predetermined piece of identity information; and
determine that the identity document is an authentic identity document after determining that the at least one piece of identity information is the same as the predetermined piece of identity information and determining that the anti-counterfeiting pattern matches the predetermined anti-counterfeiting pattern.

12. The electronic device of claim 7, wherein the identity document has a portrait, and the plurality of computer-executable instructions, when executed by the processor, further cause the electronic device to:
extract the portrait from the first image;
obtain a third image of an owner of the identity document;
perform a facial comparison between the portrait and the third image to obtain a similarity parameter;
determine whether the similarity parameter is higher than a threshold value; and
determine that the owner is an authentic owner after determining that the similarity parameter is higher than the threshold value.

13. The electronic device of claim 7, wherein the plurality of computer-executable instructions, when executed by the processor, further cause the electronic device to:
display an image capturing window;
obtain a fourth image within the image capturing window;
determine whether a first facial image is presented in the fourth image;
provide an action indication after determining that the first facial image is presented in the fourth image;
obtain a fifth image within the image capturing window, wherein a second facial image is presented in the fifth image;
determine whether the second facial image meets an expression standard based on the action indication;
perform a facial comparison between the first facial image and the second facial image to obtain a similarity parameter after determining that the second facial image meets the expression standard;
determine whether the similarity parameter is higher than a threshold value; and
determine that an owner of the identity document is a live owner after determining that the similarity parameter is higher than the threshold value.

14. A non-transitory computer-readable medium that stores a plurality of computer-executable instructions, wherein the plurality of computer-executable instructions, when executed by one or more processors, cause an electronic device to perform a method for verifying an identity document, and the method comprises:
obtaining a first image;
detecting whether the identity document is presented in the first image;
determining whether a type of the identity document belongs to a predetermined type after detecting that the identity document is presented in the first image;
obtaining a second image of the identity document after determining that the type of the identity document belongs to the predetermined type, wherein the identity document in the second image presents an anti-counterfeiting pattern thereon;
determining whether the anti-counterfeiting pattern presented in the second image matches a predetermined anti-counterfeiting pattern; and
determining that the identity document is an authentic identification document after determining that the anti-counterfeiting pattern matches the predetermined anti-counterfeiting pattern.

15. The non-transitory computer-readable medium of claim 13, wherein the first image has a first area where the identity document is presented, and the method further comprises:
determining whether at least one image quality parameter corresponding to the first area meets a predetermined standard; and
determining whether the anti-counterfeiting pattern presented in the second image matches the predetermined anti-counterfeiting pattern after determining that the at least one image quality parameter meets the predetermined standard.

16. The non-transitory computer-readable medium of claim 13, wherein the method further comprises:
determining whether a color of the identity document presented in the first image matches a predetermined color after determining that the type of the identity document belongs to the predetermined type; and
obtaining the second image of the identity document after determining that the color matches the predetermined color and determining that the type of the identity document belongs to the predetermined type.

17. The non-transitory computer-readable medium of claim 13, wherein the method further comprises:
performing an optical character recognition on the identity document presented in the first image to obtain at least one piece of identity information;
determining whether the at least one piece of identity information is the same as a predetermined piece of identity information; and
determining that the identity document is an authentic identity document after determining that the at least one piece of identity information is the same as the predetermined piece of identity information and determining that the anti-counterfeiting pattern matches the predetermined anti-counterfeiting pattern.

18. The non-transitory computer-readable medium of claim 13, wherein the identity document has a portrait, and the method further comprises:
extracting the portrait from the first image;
obtaining a third image of an owner of the identity document;
performing a facial comparison between the portrait and the third image to obtain a similarity parameter;
determining whether the similarity parameter is higher than a threshold value; and
determining that the owner is an authentic owner after determining that the similarity parameter is higher than the threshold value.

19. The non-transitory computer-readable medium of claim 13, wherein the method further comprises:
displaying an image capturing window;
obtaining a fourth image within the image capturing window;
determining whether a first facial image is presented in the fourth image;
providing an action indication after determining that the first facial image is presented in the fourth image;
obtaining a fifth image within the image capturing window, wherein a second facial image is presented in the fifth image:
determining whether the second facial image meets an expression standard based on the action indication; performing a facial comparision between the first facial image and the second facial image to obtain a similiarity parameter after determining that the second facial image meets the expression standard;
determining whether the simiiattity parameter is higher than a threshold value; and,
determining that an owner of the identity document is a live owner after determining that the similiarity parameter is higher than the threshold value.
